(19) United States
(12) Patent Application Publication
(10) Pub. No.: US 2026/0342808 A1
(43) Pub. Date: Oct. 29, 2026

(54) PROGRESSIVE MESSAGE AUTHENTICATION APPARATUS AND METHOD FOR PROTECTING STREAM DATA COMMUNICATION

(71) Applicant: ELECTRONICS AND TELECOMMUNICATIONS RESEARCH INSTITUTE, Daejeon (KR)

(72) Inventors: Joung-Il YUN, Daejeon (KR); Byoung-Koo KIM, Daejeon (KR); Seung-Yong YOON, Daejeon (KR); Dae-Won KIM, Daejeon (KR); You-Sung KANG, Daejeon (KR)

(21) Appl. No.: 19/535,205

(22) Filed: Feb. 10, 2026

(30) Foreign Application Priority Data
Apr. 29, 2025 (KR) 10-2025-0056357

(51) Int. Cl. H04L 9/40

(52) U.S. Cl. CPC H04L 63/123; H04L 63/08; H04L 63/0861

(57) ABSTRACT

Disclosed herein is a progressive message authentication apparatus and method for protecting stream data communications. The progressive message authentication apparatus may include storage and a controller. The storage may store dependency sets and accumulated state information, and the controller may generate an intermediate authentication tag and a state information tag based on a message, extract bits from the intermediate authentication tag and the accumulated state information based on the dependency sets, generate an authentication tag by performing operations on the extracted bits, and update the accumulated state information based on the state information tag.

### CROSS REFERENCE TO RELATED APPLICATION

This application claims the benefit of Korean Patent Application No. 10-2025-0056357, filed Apr. 29, 2025, which is hereby incorporated by reference in its entirety into this application.

### BACKGROUND OF THE INVENTION

### 1. Technical Field

The present disclosure relates generally to network security and data integrity verification technology, and more particularly to an apparatus and method for progressive message authentication for protecting short-stream data communications in interference-prone wireless environments.

### 2. Description of the Related Art

Message integrity verification and authentication are important factors in network security and play a critical role particularly in data transmission environments in which reliability is important. Existing message integrity verification and authentication methods may be broadly classified into Message Authentication Code (MAC) based methods and various techniques for optimizing the MAC-based methods. Although general MAC-based integrity verification and authentication methods provide strong security, transmission overhead as a function of tag length has been pointed out as a problem. Accordingly, various MAC aggregation techniques have been studied to improve the efficiency of message authentication.

A truncated MAC is a technique that reduces transmission and storage overhead in resource-constrained environments by reducing the size of a tag generated through a standard MAC (e.g., GHASH in GCM). For example, a 128-bit MAC may be truncated to 32 or 16 bits and transmitted along with a message, and a receiver uses the truncated MAC to perform integrity verification and authentication of the message. This method minimizes bandwidth and memory usage and does not introduce latency in real-time applications, so it is suitable for scenarios requiring fast responses. However, reducing the tag size significantly decreases security, which increases the probability that attackers can randomly guess a tag for an arbitrary message. Also, this method is vulnerable to network-level interference, so there is a possibility that attackers can compromise authentication security.

A compound MAC method performs cumulative authentication by grouping a plurality of messages into a single message batch. This method may be implemented by generating a single tag for authenticating all messages in the batch and by providing the single tag to a receiver after transmission of the final message or by dividing a batch tag to be transmitted across individual messages.

This method reduces bandwidth overhead by optimizing tag transmission and improves resource efficiency by reducing the number of authentication operations. However, since authentication may be performed only after all messages included in the batch are successfully received, it is not suitable for real-time applications, particularly low-latency and fast control signal transmission in operational environments of drone radio controllers. Also, packet loss may affect integrity verification and authentication of the entire message batch, so interference with a single message may compromise the entire authentication process.

Progressive Message Authentication Codes (ProMACs) are techniques that progressively increase security based on received messages while maintaining an internal state. It performs authentication from an optimistic security perspective even when a tag size is reduced at initial reception, and then enhances integrity authentication by utilizing dependencies with subsequently received messages. That is, security may be improved through post-processing.

The ProMACs method may maintain progressive authentication even when a packet is lost, and it is suitable for real-time application environments because it performs message authentication immediately upon reception. However, methods using sliding-window-based dependencies are susceptible to network-level attacks such as sandwich attacks, which may invalidate multiple tags. Also, ProMACs methods have a limitation in which the number of successfully received consecutive messages required to achieve full security (e.g., 128-bit security) increases in inverse proportion to the tag length.

ProMACs were designed to protect integrity of messages in resource-constrained environments by reducing tag size, providing a reduced security level at first, and then progressively enhancing security through subsequent messages. However, existing ProMACs have been shown to be vulnerable to network-level interference, particularly to “sandwich attacks”, and a Randomized and Resilient Dependency Distribution (R2-D2) concept has been proposed to mitigate the vulnerability. In order to address this issue, R2-D2 is designed to maintain robustness of authentication even in the presence of packet loss by reconstructing and randomizing message dependencies.

The first feature of R2-D2 is the use of Golomb ruler-based dependency distributions. Existing ProMACs rely on consecutive message histories using a sliding-window approach, but R2-D2 uses a mathematical structure known as a Golomb ruler to interleave dependencies between messages. A Golomb ruler is defined as an integer set in which each pair has a unique distance, thereby minimizing overlap between tags. For example, when a Golomb ruler such as [0, 1, 4, 6] is used, the impact of a single packet loss on the integrity protection of a specific message may be limited to a single tag. This resolves the problem in which two packet losses compromise authentication of multiple messages in a sandwich attack, and distributes the impact of lost packets on the entire message stream.

The second feature is a security level independent of tag length through a g-Sidon set. R2-D2 adopts a g-Sidon set, which is a generalization of the Golomb ruler, so that a user can parameterize maximum security loss per packet loss. A g-Sidon set is a set configured such that any identical distance between two marks occurs at most g times, thereby guaranteeing a fixed upper bound on security loss regardless of tag size. Accordingly, R2-D2 may flexibly adjust the tradeoff between authentication latency and security and enable optimization for various application scenarios. This overcomes the limitation of existing ProMACs, in which a security-latency relationship is fixed according to tag size.

The third feature is randomized bit dependencies. R2-D2 is designed such that each tag bit depends on a different message set. A dependency set D is pseudo-randomly generated based on a secret key shared between a sender and a receiver, making it difficult for attackers to predict which messages should be targeted for loss. For example, when a tag is four bytes, each of the 32 bits may be associated with a different g-Sidon set, and the randomness of these dependencies significantly reduces the feasibility of sandwich attacks. Also, distributing dependencies at the bit level prevents tag size from directly determining the security level, thereby enabling finer adjustment of the balance between security and latency.

Finally, R2-D2 adopts immediate protection bits to provide additional robustness. These bits are configured to depend only on the current message, thereby guaranteeing minimal immediate protection even in the presence of network interference or packet loss. For example, allocating 16 bits of a 4-byte tag as immediate protection bits may maintain a basic minimal security level of the message even if any previous packets are lost. This resolves the problem of existing ProMACs in which packet loss may compromise all integrity protection, and improves authentication reliability particularly in environments with a high packet loss rate. By including immediate protection bits, R2-D2 prevents worst-case scenarios in which lost packets completely collapse overall security.

R2-D2 provides a theoretical foundation for randomizing message dependencies at the bit level and enhancing resilience, and an SP-MAC algorithm has been proposed as a method for implementing R2-D2.

FIG. 8 is a view illustrating a MAC aggregation and tag generation process using conventional MAC computation of SP-MAC and efficient XOR operations. In FIG. 8, only 6 bits of the MAC computation are illustrated.

Referring to FIG. 8, SP-MAC is a ProMACs method based on the design of R2-D2 that maintains resource efficiency while being robust to network interference by utilizing conventional MAC and efficient XOR operations.

### SUMMARY OF THE INVENTION

An object of the present disclosure is to provide a progressive message authentication apparatus and method for protecting stream data communications in order to effectively verify message integrity in environments with limited transmission bandwidth and computational resources.

Another object of the present disclosure is to provide a progressive message authentication apparatus and method for protecting stream data communications, which perform progressive message authentication robust to interference, such as signal reception errors and network-level attacks (e.g., packet loss and deletion), during encryption and communication processes for protecting short message data (control and status information) transmitted as a stream in wireless communication environments requiring real-time performance, such as operational environments of drone radio controllers, Internet of Things (IoT) environments, and vehicular communication environments.

A further object of the present disclosure is to provide a progressive message authentication apparatus and method for protecting stream data communications in order to protect short data transmitted as a real-time stream at short intervals in interference-prone wireless communication environments.

Yet another object of the present disclosure is to provide a progressive message authentication apparatus and method for protecting stream data communications, which utilize Authenticated Encryption with Associated Data (AEAD) based encryption techniques to simultaneously guarantee both confidentiality and authentication, thereby enhancing communication security.

Still another object of the present disclosure is to provide a progressive message authentication apparatus and method for protecting stream data communications in order to protect control data of 16 bytes or less for a drone radio controller.

A method for progressive message authentication for protecting stream data communications according to the present disclosure may include generating an intermediate authentication tag and a state information tag based on a message, extracting bits from the intermediate authentication tag and accumulated state information based on dependency sets, generating an authentication tag by performing operations on the extracted bits, and updating the accumulated state information based on the state information tag.

Generating the intermediate authentication tag and the state information tag may include encrypting the message based on Authenticated Encryption with Associated Data (AEAD) to generate an initial tag and generating the intermediate authentication tag and the state information tag based on the initial tag.

The intermediate authentication tag may be generated using the following equation:

$${t}_{i}^{c u r} = {⊕}_{l}^{L} = {⊕}_{0 \leq k < ( \frac{L}{l} )} {[ {t}_{i} ]}_{k \cdot l + 1 : ( k + 1 ) \cdot l}$$

where tᵢ denotes the initial tag,

$${t}_{i}^{c u r}$$

denotes the intermediate authentication tag, L denotes the length of tᵢ, l denotes the length of the authentication tag and may be set to satisfy l<L, and i denotes a value indicating a sequence number of the message.

The state information tag may be generated using the following equation:

$${t}_{i}^{p r o} = {⊕}_{{l}^{p r o}}^{L} = {⊕}_{0 \leq k < ( \frac{L}{{l}^{pro}} )} {[ {t}_{i} ]}_{k \cdot {l}^{p r o} + 1 : ( k + 1 ) \cdot {l}^{p r o}}$$

where tᵢ denotes the initial tag,

$${t}_{i}^{p r o}$$

denotes the state information tag, L denotes the length of tᵢ, l^{pro} denotes the bit length of a portion of the authentication tag for progressive authentication and may be set to satisfy l^{pro}<l, i denotes a value indicating a sequence number of the message, and l denotes the length of the authentication tag and may be set to satisfy l<L.

The dependency sets may be sets selected from among sets satisfying a (g, e)-Sidon set. The sets satisfying the (g, e)-Sidon set may be selected from among g-Sidon sets such that any identical element other than ‘0’ occurs at most e times among the selected sets. The dependency sets may be selected from among the sets satisfying the (g, e)-Sidon set based on a random number sequence generated by a pseudorandom function using a secret key used to encrypt the message as a seed.

The length of the accumulated state information may be set to the largest value among all elements of the dependency sets.

Generating the intermediate authentication tag and the state information tag may include changing the bit order of the generated intermediate authentication tag based on a random number generated using a nonce used with a secret key used to encrypt the message as a seed.

The authentication tag may be generated using the following equation:

$${[ {t}_{i}^{agg} ]}_{m} = \{ \begin{matrix}( {⊕}_{d ∈ {D}_{m}} \{ \begin{matrix}{[ {t}_{i}^{′ cur} ]}_{m} & if d = 0 \\ {[ {t}_{i - d}^{′ pro} ]}_{m} & else\end{matrix} ) & if 1 \leq m \leq {l}^{pro} \\ {[ {t}_{i}^{′ cur} ]}_{m} & else\end{matrix}$$

where

$${t}_{i}^{a g g}$$

denotes the authentication tag,

$${t}_{i}^{′ c u r}$$

denotes the intermediate authentication tag with the changed bit order,

$${t}_{i}^{p r o}$$

denotes the state information tag, Dₘ denotes an m-th set among the dependency sets, l^{pro} denotes the bit length of a portion of

$${t}_{i}^{a g g}$$

for progressive authentication, and i denotes a value indicating a sequence number of the message.

An apparatus for progressive message authentication for protecting stream data communications according to the present disclosure may include storage configured to store dependency sets and accumulated state information and a controller configured to generate an intermediate authentication tag and a state information tag based on a message, extract bits from the intermediate authentication tag and the accumulated state information based on the dependency sets, generate an authentication tag by performing operations on the extracted bits, and update the accumulated state information based on the state information tag.

The controller may encrypt the message based on Authenticated Encryption with Associated Data (AEAD) to generate an initial tag and may generate the intermediate authentication tag and the state information tag based on the initial tag.

The intermediate authentication tag may be generated using the following equation:

$${t}_{i}^{c u r} = {⊕}_{l}^{L} = {⊕}_{0 \leq k < ( \frac{L}{l} )} {[ {t}_{i} ]}_{k \cdot l + 1 : ( k + 1 ) \cdot l}$$

where tᵢ denotes the initial tag,

$${t}_{i}^{c u r}$$

denotes the authentication tag, L denotes the length of tᵢ, l denotes the length of the authentication tag and may be set to satisfy l<L, and i denotes a value indicating a sequence number of the message.

The state information tag may be generated using the following equation:

$${t}_{i}^{p r o} = {⊕}_{{l}^{p r o}}^{L} = {⊕}_{0 \leq k < ( \frac{L}{l p r o} )} {[ {t}_{i} ]}_{k \cdot {l}^{p r o} + 1 : ( k + 1 ) \cdot {l}^{p r o}}$$

where tᵢ denotes the initial tag,

$${t}_{i}^{p r o}$$

denotes the state information tag, L denotes the length of tᵢ, l^{pro} denotes the bit length of a portion of the authentication tag for progressive authentication and may be set to satisfy l^{pro}<l, i denotes a value indicating a sequence number of the message, and l denotes the length of the authentication tag and may be set to satisfy l<L.

The dependency sets may be sets selected from among sets satisfying a (g, e)-Sidon set. The sets satisfying the (g, e)-Sidon set may be selected from among g-Sidon sets such that any identical element other than ‘0’ occurs at most e times among the selected sets. The dependency sets may be selected from among the sets satisfying the (g, e)-Sidon set based on a random number sequence generated by a pseudorandom function using a secret key used to encrypt the message as a seed.

The length of the accumulated state information may be set to the largest value among all elements of the dependency sets.

The controller may change the bit order of the generated intermediate authentication tag based on a random number generated using a nonce used with a secret key used to encrypt the message as a seed.

The authentication tag may be generated using the following equation:

$${[ {t}_{i}^{a g g} ]}_{m} = \{ \begin{matrix}( {⊕}_{d ∈ {D}_{m}} \{ \begin{matrix}{[ {t}_{i}^{′ cur} ]}_{m} & if d = 0 \\ {[ {t}_{i - d}^{pro} ]}_{m} & else\end{matrix} ) & if 1 \leq m \leq {l}^{pro} \\ {[ {t}_{i}^{′ cur} ]}_{m} & else\end{matrix}$$

where

$${t}_{i}^{a g g}$$

denotes the authentication tag,

$${t}_{i}^{′ c u r}$$

denotes the intermediate authentication tag with the changed bit order,

$${t}_{i}^{p r o}$$

denotes the state information tag, Dₘ denotes an m-th set among the dependency sets, l^{pro} denotes the bit length of a portion of

$${t}_{i}^{a g g}$$

for progressive authentication, and i denotes a value indicating a sequence number of the message.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating the configuration of a progressive message authentication apparatus for protecting stream data communications according to an embodiment of the present disclosure;

FIG. 2 is a view illustrating an example of an encryption process based on AEAD and a tag generation process for authentication;

FIG. 3 is a view illustrating an example of tag truncation for reducing transmission bandwidth overhead;

FIG. 4 is a view illustrating a basic concept diagram of progressive message authentication;

FIG. 5 is a view illustrating an embodiment of a (g, e)-Sidon set generation algorithm according to the present disclosure;

FIG. 6 is a configuration diagram illustrating a process of performing a progressive message authentication method for protecting stream data communications according to an embodiment of the present disclosure;

FIG. 7 is a view illustrating an example of a process of performing a progressive message authentication method for protecting stream data communications according to an embodiment of the present disclosure; and

FIG. 8 is a view illustrating a MAC aggregation and tag generation process through conventional MAC computation of SP-MAC and efficient XOR operations.

### DESCRIPTION OF THE PREFERRED EMBODIMENTS

Because the present disclosure may be variously changed and may have various embodiments, specific embodiments will be described in detail below with reference to the attached drawings. However, it should be understood that those embodiments are not intended to limit the present disclosure to specific disclosure forms and that they include all changes, equivalents or modifications included in the spirit and scope of the present disclosure.

Specific embodiments will be described in detail below with reference to the attached drawings. These embodiments are described in sufficient detail to enable those skilled in the art to practice the embodiments. It should be understood that the embodiments differ from each other, but the embodiments do not need to be exclusive of each other. For example, a particular feature, structure, or characteristic described herein in connection with one embodiment may be implemented in another embodiment without departing from the spirit or scope of the present disclosure. Also, it should be understood that the location or arrangement of individual elements in the disclosed embodiments may be changed without departing from the spirit or scope of the embodiments. Therefore, the following detailed description is not to be taken in a limiting sense, and if appropriately interpreted, the scope of the exemplary embodiments is limited only by the appended claims, along with the full range of equivalents to which the claims are entitled.

In the drawings, similar reference numerals are used to designate the same or similar functions in various aspects. The shapes, sizes, etc. of components in the drawings may be exaggerated to make the description clearer. Also, the terms “and/or” may include combinations of a plurality of related described items or any of a plurality of related described items. The terms “part,” “unit,” and “module” as used herein may include one or more components, and may include software components and/or hardware components.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure. Similarly, a second element could also be referred to as a first element.

It will be understood that when a component is referred to as being “connected” or “coupled” to another component, the two components may be directly connected or coupled to each other, or intervening components may be present between the two components. It will be understood that when a component is referred to as being “directly connected or coupled” to another component, no intervening components are present between the two components.

Components in embodiments are independently illustrated in order to indicate different characteristic functions, but this does not mean that each of the components is formed of a separate piece of hardware or software. That is, components are arranged and included for convenience of description, and at least two of the components may form one component, or one component may be divided into multiple components to perform respective functions. An embodiment into which the components are integrated or an embodiment from which some components are separated is included in the scope of the present disclosure, as long as it does not depart from the essence of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. That is, in the embodiments, an expression describing that a component “comprises” a specific component means that additional components may be included within the scope of the practice of the present disclosure or the technical spirit of the present disclosure, but does not preclude the presence of components other than the specific component.

In the embodiments, the term “at least one” may mean one of one or more numbers, such as 1, 2, 3, and 4. In the embodiments, the term “a plurality of” may mean one of two or more numbers, such as 2, 3 and 4.

At least portion of the parts, units, and modules described in the embodiments may be program modules and may communicate with external devices or systems.

The program modules may include a routine, a subroutine, a program, an object, a program component, a data structure, and the like for performing functions or operations according to an embodiment or for implementing abstract data types according to an embodiment, but they are not limited thereto.

Some components of embodiments are not essential components for performing essential functions, but may be optional components for improving only performance. The embodiments may be implemented by including only essential components for implementing the essence of the embodiments, excluding components used only to improve performance. For example, a structure including only essential components, excluding optional components used only to improve performance, is also included in the scope of the embodiments.

Hereinafter, embodiments will be described in detail below with reference to the accompanying drawings so that those having ordinary knowledge in the technical field can easily practice the embodiments. In the following description of the embodiments, detailed descriptions of known functions or configurations which are deemed to obscure the gist of the present specification will be omitted. Further, the same reference numerals are used to designate the same components throughout the drawings, and repeated descriptions of the same components will be omitted.

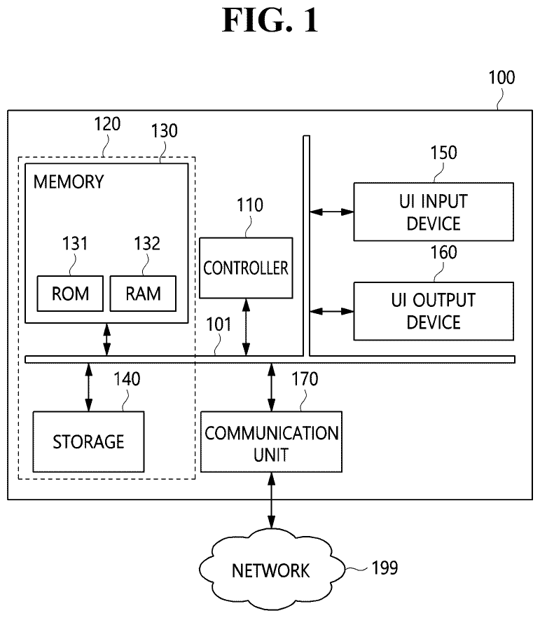

FIG. 1 is a view illustrating the configuration of a progressive message authentication apparatus for protecting stream data communications according to an embodiment of the present disclosure.

Referring to FIG. 1, the progressive message authentication apparatus 100 for protecting stream data communications according to the present disclosure may include a bus 101, a controller 110, storage 120, a user interface (UI) input device 150, a UI output device 160, and a communication unit 170. The storage 120 may include memory 130 and storage 140. The controller 110, the memory 130, the storage 140, the UI input device 150, the UI output device 160, and the communication unit 170 may communicate with each other via the bus 101. The progressive message authentication apparatus 100 may be implemented in or incorporated into a drone, a drone radio controller, an IoT device, a vehicular communication device, a robot, or a robot control device.

The controller 110 may be a semiconductor device for executing processing instructions stored in the storage 120. The controller 110 may be at least one hardware processor. The controller 110 may be configured with one or more cores and may include processors for data analysis and deep learning, such as a Central Processing Unit (CPU), a Graphics Processing Unit (GPU), a Digital Signal Processor (DSP), an Application-Specific Integrated Circuit (ASIC), a General-Purpose Graphics Processing Unit (GPGPU), a Tensor Processing Unit (TPU), and the like. The controller 110 may read a computer program stored in the storage 120 and perform a progressive message authentication method for protecting stream data communications according to an embodiment of the present disclosure.

Program modules may be configured with instructions or code executed by at least one processor of the controller 110. The program modules may be included in the progressive message authentication apparatus 100 in the form of operating systems, application modules, and other program modules. The program modules may be physically stored on various known memory devices. Also, at least part of the program modules may be stored in a remote memory device that can communicate with the communication unit 170.

The controller 110 may execute instructions or code of the parts, units, and modules described in the embodiments.

The storage 140 may be storage media including at least one of a nonvolatile medium, a detachable medium, a non-detachable medium, a communication medium, or an information delivery medium, or a combination thereof.

The memory 130 may include ROM 131 or RAM 132.

The communication unit 170 may transmit and receive data to and from other progressive message authentication apparatuses, a remote memory device, or a server over a network 199. Here, the network 199 may be a private network, or an Internet network, and may include a wired network or a wireless network. The network 199 may indicate one or more portions of a network that may be an ad-hoc network, an intranet, an extranet, Bluetooth, ZigBee, a Virtual Private Network (VPN), a Local Area Network (LAN), a Wireless LAN (IEEE 802.11b, IEEE 802.11a, IEEE 802.11g, IEEE 802.11n), a Wireless Broadband (WiBro), a Wide Area Network (WAN), a wireless WAN (WWAN), a Metropolitan Area Network (MAN), the Internet, a portion of the Internet, a portion of a Public Switched Telephone Network (PSTN), a Plain Old Telephone Service (POTS) network, a cellular telephone network, a wireless network, a Wi-Fi® network, another type of network, or a combination of two or more of these networks, and may indicate one or more portions of a network connected to another type of network. For example, the network or a portion thereof may include a wireless or cellular network, and the connection may be a Code Division Multiple Access (CDMA) connection, a Global System for Mobile communications (GSM) connection, or another type of cellular or wireless connection. In such an example, the connection may be implemented by any of various types of data transmission technologies, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standards, other technologies defined by various standard establishing organizations, other long-distance protocols, or other data transmission technologies.

The storage 120 may store dependency sets and accumulated state information.

The controller 110 may generate an intermediate authentication tag and a state information tag based on a message. The controller 110 may encrypt the message based on Authenticated Encryption with Associated Data (AEAD) to generate an initial tag, and may generate an intermediate authentication tag and a state information tag based on the generated initial tag.

The controller 110 may generate an intermediate authentication tag using Equation (1) below:

$${t}_{i}^{c u r} = {⊕}_{l}^{L} = {⊕}_{0 \leq k < ( \frac{L}{l} )} {[ {t}_{i} ]}_{k \cdot l + 1 : ( k + 1 ) \cdot l} \qquad ( 1 )$$

Here, tᵢ denotes the initial tag,

$${t}_{i}^{c u r}$$

denotes the intermediation authentication tag, L denotes the length of tᵢ, l denotes the length of an authentication tag, which may be set to satisfy l<L, and i denotes a value indicating the sequence number of the message.

The main symbols and notations used in the present disclosure are defined and described as shown in the following table:

| | |
|---|---|
| [A]ₓ | the x-th bit of bit sequence A (assuming that bit indices |
| | start from 1 in the present disclosure) |
| [A]_{x:y} | the sub-bit sequence of bit sequence A from the x-th to y-th bits |
| A ⊕ B | the bitwise XOR of equal-length bit sequences A and B |
| ⊕_{x≤k≤y} | iterative XOR operations for k in a given range |

In addition, the controller 110 may further change the bit order of the generated intermediate authentication tag based on a random number generated using a nonce used with a secret key used to encrypt the message as a seed.

The controller 110 may generate a state information tag using Equation (2) below:

$${t}_{i}^{p r o} = {⊕}_{{l}^{p r o}}^{L} = {⊕}_{0 \leq k < ( \frac{L}{{l}^{pro}} )} {[ {t}_{i} ]}_{k \cdot {l}^{p r o} + 1 : ( k + 1 ) \cdot {l}^{p r o}} \qquad ( 2 )$$

Here, tᵢ denotes the initial tag,

$${t}_{i}^{p r o}$$

denotes the state information tag, L denotes the length of tᵢ, l^{pro} denotes the bit length of a portion of the authentication tag for progressive authentication, which may be set to satisfy l^{pro}<1, i denotes a value indicating the sequence number of the message, and l denotes the length of the authentication tag, which may be set to satisfy l<L.

The controller 110 may extract bits from the generated intermediate authentication tag and the accumulated state information based on the dependency sets stored in the storage 120 and generate an authentication tag by performing operations on the extracted bits.

The progressive message authentication apparatus 100 may provide technology for protecting short data transmitted as a real-time stream at short intervals (e.g., control data of 16 bytes or less for a drone radio controller) in interference-prone wireless communication environments. To this end, the progressive message authentication apparatus 100 utilizes AEAD-based encryption techniques to simultaneously guarantee both confidentiality and authentication, thereby enhancing communication security.

AEAD, which is an efficient security mechanism that combines encryption and authentication, simultaneously guarantees confidentiality and integrity/authentication of a message, allows additional associated data to be included in authentication, and generally uses lightweight cryptographic algorithms, such as AES-GCM (Galois/Counter Mode) or ASCON. Therefore, it is suitable for enhancing security of stream data in resource-constraint environments (drone radio controllers and IoT devices). However, an authentication value (a tag, an authentication tag) that is required to be additionally transmitted for authentication increases network transmission bandwidth overhead. In order to address this problem, the progressive message authentication apparatus 100 applies an efficient authentication mechanism, thereby providing a technical solution for maintaining security while minimizing network overhead.

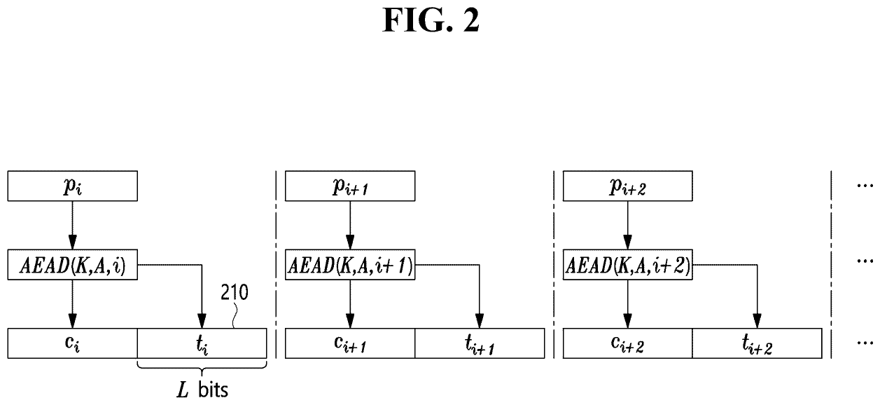

FIG. 2 is a view illustrating an example of an encryption process based on AEAD and a tag generation process for authentication.

Referring to FIG. 2, the controller 110 may encrypt a message (plaintext, Pᵢ) using an AEAD function by receiving a secret key K of the AEAD function, additional associated data A, a nonce used with the secret key K, and a counter i for identifying the sequence. In this process, an initial tag tᵢ 210 may be generated together with ciphertext Cᵢ. As shown in FIG. 2, each message Pᵢ, Pᵢ₊₁, or Pᵢ₊₂ may be independently processed without correlation. Generating the initial tag tᵢ 210 and the ciphertext Cᵢ using an AEAD function is a well-known technology, and thus a detailed description thereof will be omitted below.

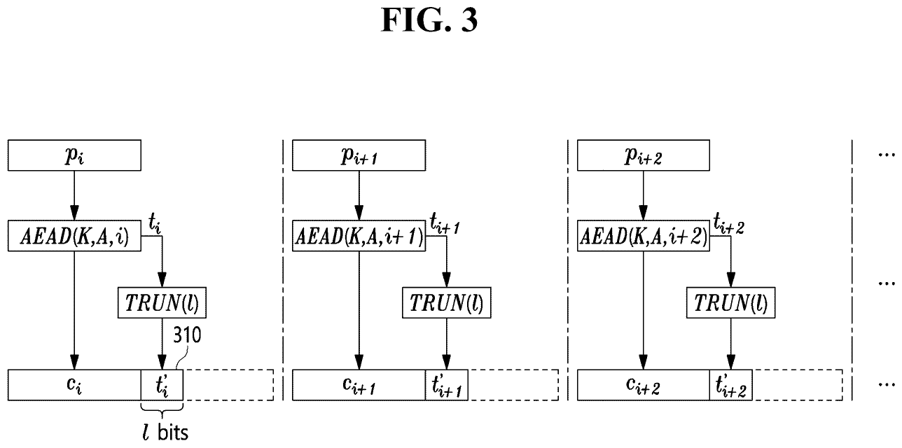

FIG. 3 is a view illustrating an example of tag truncation for reducing transmission bandwidth overhead.

Referring to FIG. 3, when the length of the initial tag 210 (a tag length L of a general AEAD algorithm is 128 bits) is relatively large compared to a message length, a method (Trun( )) of truncating the tag to 1 bits less than L may be used, as shown in FIG. 3. However, the truncated tag t′ᵢ 310 may lead to a reduction in authentication security as a tradeoff.

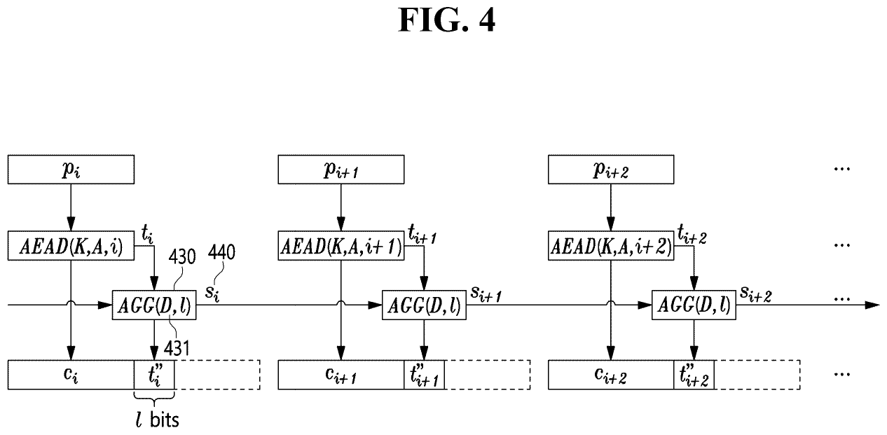

FIG. 4 is a view illustrating a basic concept diagram of progressive message authentication.

Referring to FIG. 4, the controller 110 may provide an improved method based on a basic concept of progressive message authentication, which reduces the length of the initial tag 210 to minimize overhead while preventing degradation of security strength, in order to address a problem in which authentication security strength is reduced when the initial tag 210 is truncated. The progressive message authentication technique internally accumulates and propagates accumulated state information sᵢ 440 required for authentication by utilizing subsequent messages in the process of processing Agg(D, l) 430 that is not exposed externally, thereby compensating for vulnerabilities caused by single-tag truncation and implementing an authentication framework robust to an interference environment.

In the process of processing Agg(D, l) 430, a dependency set D 431 is a key element that defines authentication dependency relationships between messages during tag generation, and it may ensure continuity of authentication by configuring a tag of a specific message to refer to information of previous or subsequent messages. Accordingly, security may be maintained even when some messages are lost. Although the above-described R2-D2 concept and SP-MAC implementation method also provide methods for determining dependency sets, the dependency set D 431 according to the present disclosure more rigorously configures the dependency set among messages, thereby providing more robust security than conventional dependency sets in wireless communication environments vulnerable to interference (e.g., packet loss, signal interference, reduced reception rates, signal interruption, network-level attacks, etc.).

R2-D2 has been proposed as a progressive message authentication framework that enhances resistance to network interference by combining randomized bit dependencies, immediate protection bits, and Golomb-Ruler (or g-Sidon Set) based dependencies. Based thereon, SP-MAC efficiently implements the concept of R2-D2 to optimize the computational load and resource usage. Specifically, R2-D2 initializes an independent pseudorandom g-Sidon set Dₖ for each tag bit, configures a portion of the tag as immediate protection bits to perform authentication based on a current message mᵢ, and uses the remaining bits for progressive authentication. For example, when a 2-byte tag is used, if 8 bits are configured as immediate protection bits (dependency set D={0}) and the remaining 8 bits are configured for progressive authentication (based on a g-Sidon set), a minimum of 8 bits of security may be ensured by the immediate protection bits even when a previous message is lost. Furthermore, progressive authentication allows security loss to be limited to only some bits associated with the dependencies of the lost message.

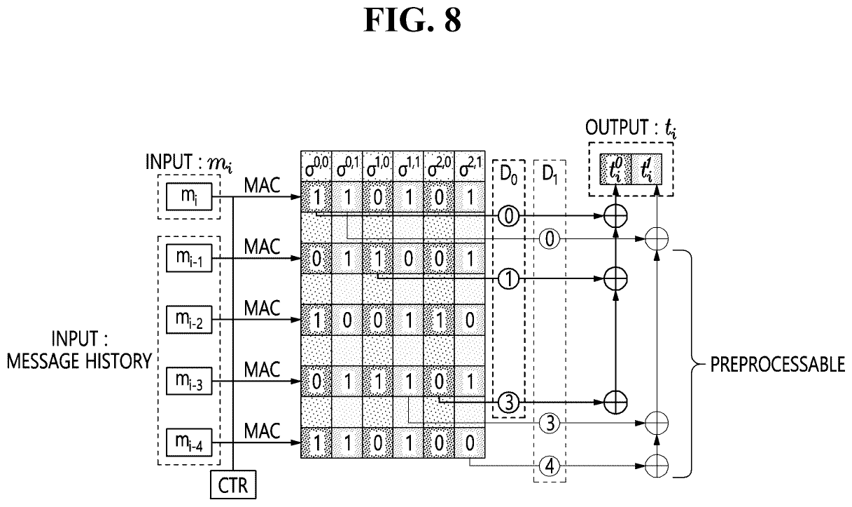

However, when randomized bit dependencies frequently cause overlapping (duplication) of offsets among Dₖ sets of a specific message, a loss of some messages may result in significant degradation of security strength. For example, since both D₀ and D₁ include 3 in FIG. 8, if the (i−3)-th message mᵢ₋₃ is lost or altered due to an attack, authentication of each corresponding bit

$$( denoted as {t}_{i}^{0} and {t}_{i}^{1} in FIG . 8 )$$

may be invalidated, thereby significantly reducing the overall authentication security strength.

In order to address this disadvantage, the present disclosure precomputes an independent g-Sidon set Dₖ for each tag bit and configures the sets such that the offsets among all Dₖ sets, that is, d∈Dₖ, do not overlap, or limits offset overlap to at most e occurrences (e.g., e=1). Furthermore, from among the precomputed sets in which overlap is minimized or limited to at most e occurrences, Dₖ is randomly selected based on a pseudorandom number generated using, as a seed, a secret key shared between a sender and a receiver and a nonce to which an identical value is applied in the encryption and decryption processes, and tag bits are dynamically configured, thereby preventing prediction of dependency patterns by an attacker and improving security.

An existing g-Sidon set is defined as a set in which a difference between every pair of elements is allowed to occur at most g times, but the present disclosure configures a dependency set 431 by further including a new condition that additionally limits the number of overlaps of elements among sets. In order to distinguish this method from the existing method, the set proposed in the present disclosure is referred to as a (g, e)-Sidon set hereinbelow.

The controller 110 may select dependency sets from among sets satisfying a (g, e)-Sidon set. Here, the sets satisfying the (g, e)-Sidon set may indicate sets selected from among g-Sidon sets such that any identical element occurs at most e times among the selected sets.

The controller 110 may select dependency sets from among the sets satisfying the (g, e)-Sidon set based on a random number sequence generated by a pseudorandom function that uses a secret key used to encrypt a message as a seed.

Also, the controller 110 may update the accumulated state information based on the generated state information tag. The controller 110 may set the number of elements of the accumulated state information to the largest value among all the elements of the dependency sets. When the number of elements of the accumulated state information becomes equal to the largest value among all the elements of the dependency sets, the controller 110 adds the state information tag to the accumulated state information and deletes the first added state information tag from the accumulated state information, thereby updating the accumulated state information. Here, the number of elements of the accumulated state information may be the same concept as the length of the accumulated state information.

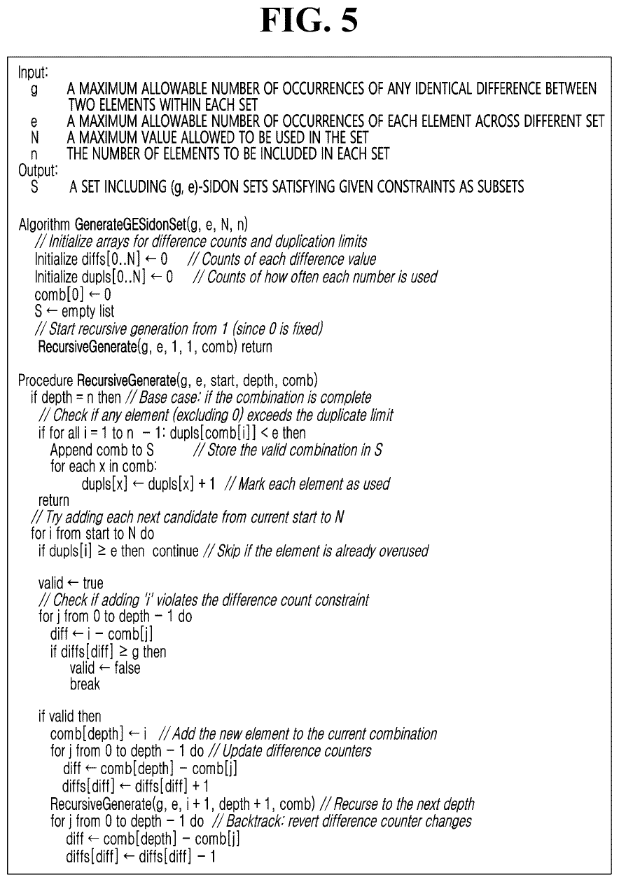

FIG. 5 is a view illustrating an embodiment of a (g, e)-Sidon set generation algorithm according to the present disclosure. FIG. 5 is an embodiment in which the (g, e)-Sidon set generation algorithm proposed in the present disclosure is represented as pseudocode.

Referring to FIG. 5, n elements are selected from among a set of integers ranging from 0 to N in the state in which the first element is fixed to 0, and a combination of the selected elements is determined to be a valid set and stored only when the combination satisfies predefined conditions. Here, the conditions require that a difference between any two selected elements does not occur more than g times and that any specific element is not used more than e times throughout the entire generation process. The algorithm is based on a recursive backtracking method and effectively reduces the overall search space by eliminating invalid candidates early at each step. Such a method is advantageous for efficiently generating integer sequences or key sets having low redundancy and a low probability of collision in environments with limited computation resources. For reference, g=1 indicates that the Golomb ruler condition is satisfied, and e=1 corresponds to the case in which no identical element is shared among sets. Accordingly, the number of sets satisfying both g=1 and e=1 is very limited, so parameters should be determined in consideration of a tradeoff with authentication security strength.

Also, N (which is a maximum value that can be used in the set) and n (which is the number of elements to be included in each set) should be determined not only based on the length of a truncated authentication tag but also on the number of subsets of S found as (g, e)-Sidon sets. For example, when the number of subsets of S is less than a bit length allocated for progressive authentication, the number of non-overlapping sets is not sufficient when dependency sets for respective bits are selected. Conversely, when N is set to a large value in order to secure a greater number of subsets, a tag is required to be configured and verified based on dependency relationships with a wider range of previous messages, thereby increasing a likelihood of authentication latency.

Accordingly, in the present disclosure, N is progressively increased in the state in which parameters n, g, and e are fixed, and S (which is a set including (g, e)-Sidon sets satisfying given constraint conditions as subsets) is selected at a point where the number of subsets of S exceeds the length of bits allocated for progressive authentication. Such a process requires substantial computation. However, in the present disclosure, this process is performed in advance (offline) using separate computing power according to parameter combinations, and results are stored in the storage in the form of a precomputed table. Then, this is applied on the assumption that a sender and a receiver share an identical collection of (g, e)-Sidon sets according to the selected parameters, thereby enabling effective use even in environments with limited computing resources. Here, the progressive message authentication apparatus 100 according to the present disclosure may be a sender when it encrypts plaintext and transmits the ciphertext to a receiver, and may be a receiver when it receives ciphertext from a sender and decrypts the ciphertext.

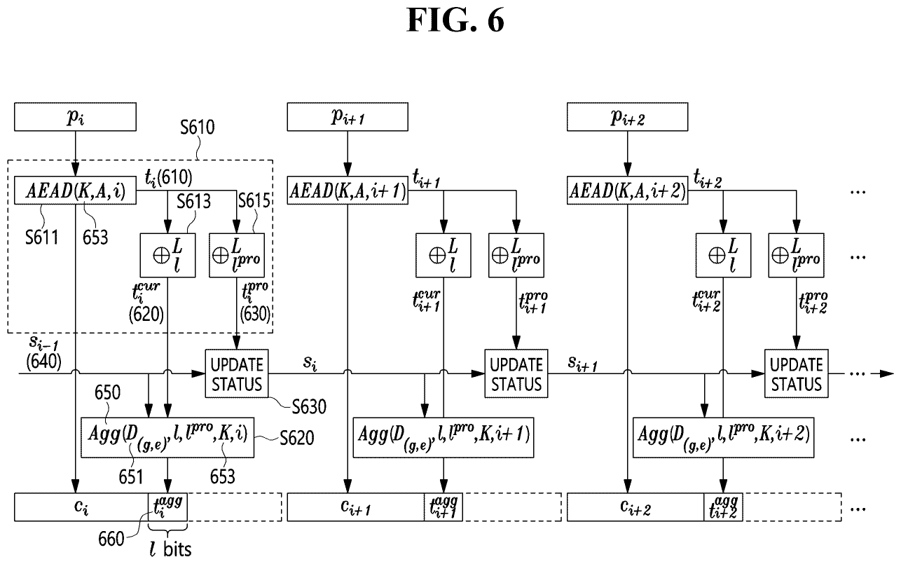

FIG. 6 is a configuration diagram illustrating a process of performing a progressive message authentication method for protecting stream data communications according to an embodiment of the present disclosure. FIG. 6 illustrates a configuration diagram for implementing a progressive message authentication method based on the above-described (g, e)-Sidon set.

Referring to FIG. 6, the controller 110 generates an intermediate authentication tag 620 and a state information tag 630 based on a message at step S610. Step S610 may include steps S611, S613, and S615.

The controller 110 extracts bits from the intermediate authentication tag 620 and accumulated state information 640 based on a dependency set 651 and generates an authentication tag 660 by performing operations on the extracted bits at step S620.

The controller 110 updates the accumulated state information 640 based on the state information tag 630 at step S630.

At step S611, the controller 110 generates an initial tag tᵢ 610 having a length of L, which is generally 128 bits, by encrypting a current message (i-th message), mᵢ, based on AEAD.

After step S610, the controller 110 generates a final truncated authentication tag

$${t}_{i}^{a g g}$$

660 through a MAC aggregation process at step S620. The bit length of the truncated authentication tag

$${t}_{i}^{a g g}$$

660 is set to l, and the bit length of a portion of the authentication tag 660 for progressive authentication is set to l^{pro} (<l). At step S610, the controller 110 generates two truncated tags, which are an intermediate authentication tag 620 and a state information tag 630. At step S613, the controller 110 generates the intermediate authentication tag

$${t}_{i}^{c u r}$$

620 using Equation (1) described above. At step S615, the controller 110 generates the state information tag

$${t}_{i}^{p r o}$$

630 using Equation (2) described above. Hereinafter, L is assumed to be a multiple of l and l^{pro} for convenience of description.

In Equation (1),

$${t}_{i}^{c u r}$$

620 includes bits for progressive authentication, which depends only on the current message, and immediate protection bits (having a bitlength of l^{imm}=l−l^{pro}), and it is used only in the MAC aggregation process for

$${t}_{i}^{agg}$$

660.

In contrast,

$${t}_{i}^{pro}$$

630 in Equation (2) may be used for calculating bits for progressive authentication of subsequent messages. In the state update process of step S630, the controller adds a new state information tag

$${t}_{i}^{pro}$$

630 and deletes the oldest entry, thereby updating and transferring the accumulated state information sᵢ 640. Here, the number of accumulated entries of sᵢ 640 may be set to the largest value, among all the elements of a dependency set D 651, which is randomly selected from among subsets of a (g, e)-Sidon set generated according to the parameter settings described above by using a pseudorandom function to be described later. For example, when the value of the largest element is v, the accumulated state information may be updated as follows

$$…$$

$${s}_{i - 1} = \{ {t}_{i - v}^{p r o} , {t}_{i - v + 1}^{p r o} , … , {t}_{i - 1}^{p r o} \}$$

$${s}_{i} = \{ {t}_{i - v + 1} , {t}_{i - v + 2}^{p r o} , … , {t}_{i}^{p r o} \}$$

$$s = \{ {t}_{i - v + 2} , {t}_{i - v + 3}^{p r o} , … , {t}_{i + 1}^{p r o} \}$$

$${s}_{i + 2} = \{ {t}_{i - v + 3} , {t}_{i - v + 4}^{p r o} , … , {t}_{i + 2}^{p r o} \}$$

$$…$$

In the present disclosure, the accumulated state information is configured by accumulating only

$${t}_{i}^{pro}$$

630 in order to minimize memory consumption. Also, when a message is not received due to a problem, such as interference or the like, the controller 110 may update the accumulated state information by adding a specific bit flag (e.g., −1) to indicate an ‘invalid value’. Accordingly, whether a previous message is received may be determined in the tag aggregation process to be described later, whereby unnecessary operations may be reduced.

The MAC aggregation process is executed in Agg(D_{(g,e)}, l, l^{pro}, K, i) 650. It receives the previously accumulated state information sᵢ₋₁ and

$${t}_{i}^{cur}$$

for the current message and operates according to the settings of the parameters D_{(g,e)}, l, l^{pro}, K, and i. Here, D_{(g,e)} 651 is a set precomputed using the above-described (g, e)-Sidon set generation algorithm, and a nonce, which is synchronized using the secret key K 653 and a counter i for identifying a message order and is privately shared, is used as a seed for enhancing pseudo-randomness. Here, the nonce may be associated with the secret key K 653.

Specifically, the present disclosure proposes a method of generating a tag for progressive message authentication as follows:

### 1. Configuring D_{(g,e)} According to Parameter Settings.

The number of subsets of a (g, e)-Sidon set S according to parameter settings is always greater than l^{pro}, as described above. Also, the length of the accumulated state information sᵢ is set to the largest value among all the elements of a randomly selected dependency set D. Accordingly, the controller 110 may configure D_{(g,e)} to include l^{pro} subsets selected from the (g, e)-Sidon set S in ascending order of the maximum element of each subset in order to improve memory efficiency for maintaining the state information.

### 2. Selecting Dependency Set D Based on a Random Number Synchronized Between a Sender and a Receiver

In order to randomly select l^{pro} subsets from D_{(g,e)}, a sender and a receiver use the secret key K 653 as a seed of an identical pseudorandom function. Accordingly, a pseudorandom sequence generated therefrom, which is known only to the sender and the receiver, is used to select D={D₁, D₂, . . . , Dₗ_{^{pro}}}. In the present disclosure, a Fisher-Yates shuffle algorithm, which is a representative algorithm for generating a random permutation by shuffling an array, may be employed as the selection method using a pseudorandom function, but the present disclosure is not limited thereto. Also, for operation efficiency, the selected dependency set D 651 may be maintained as long as the secret key K 653 remains unchanged.

### 3. Applying Dynamic Randomness for Each Message.

In order to dynamically apply randomness for each message, a random number may be generated using, as a seed, a nonce that is identically used in an encryption process by a sender and a decryption process by a receiver. By utilizing the generated random number, the controller 110 may generate

$${t}_{i}^{′ cur}$$

by changing the bit order of

$${t}_{i}^{cur}$$

at step S610.

### 4. Generating Final Aggregated Truncated Tag

$${t}_{i}^{agg}$$

At step S620, using

$${t}_{i}^{′ cur}$$

and the previously accumulated state information

$${s}_{i - 1} = \{ {t}_{i - v}^{pro} , {t}_{i - v + 1}^{pro} , … , {t}_{i - 1}^{pro} \} ,$$

the controller 110 may generate

$${t}_{i}^{agg}$$

660 based on Equation (3) below:

$${[ {t}_{i}^{agg} ]}_{m} = \{ \begin{matrix}( {⊕}_{d ∈ {D}_{m}} \{ \begin{matrix}{[ {t}_{i}^{′ cur} ]}_{m} & if d = 0 \\ {] {t}_{i - d}^{pro} ]}_{m} & else\end{matrix} ) & if i \leq m \leq {l}^{pro} \\ {[ {t}_{i}^{′ cur} ]}_{m} & else\end{matrix} \qquad ( 3 )$$

In some embodiments, using

$${t}_{i}^{cur}$$

instead of

$${t}_{i}^{′ cur} ,$$

together with the previously accumulated state information

$${s}_{i - 1} = \{ {t}_{i - v}^{p r o} , {t}_{i - v + 1}^{p r o} , … , {t}_{i - I}^{p r o} \}$$

at step S620, the controller 110 may generate

$${t}_{i}^{a g g}$$

660 based on Equation (4) below. Equation (4) differs from Equation (3) in that

$${t}_{i}^{c u r}$$

is used instead of

$${t}_{i}^{′ c u r} .$$

$${[ {t}_{i}^{agg} ]}_{m} = \{ \begin{matrix}( {⊕}_{d ∈ {D}_{m}} \{ \begin{matrix}{[ {t}_{i}^{cur} ]}_{m} & if d = 0 \\ {[ {t}_{i - d}^{pro} ]}_{m} & else\end{matrix} ) & if 1 \leq m \leq {l}^{pro} \\ {[ {t}_{i}^{cur} ]}_{m} & else\end{matrix} \qquad ( 4 )$$

### 5. Processing ‘Invalid Value’ and Optimization

Before calculating each bit of

$${t}_{i}^{a g g}$$

660 based on Equation (3) or (4) at step S620 when it is determined that the accumulated state information includes a flag indicating an ‘invalid value’, operations associated with elements of the corresponding dependency set need not be performed (the operations may be omitted). In this case, the corresponding bit of

$${t}_{i}^{a g g}$$

is treated as a ‘don't care’ value, and the controller 110 may exclude the bit from authentication tag verification and perform authentication tag verification by adjusting a security strength criterion accordingly.

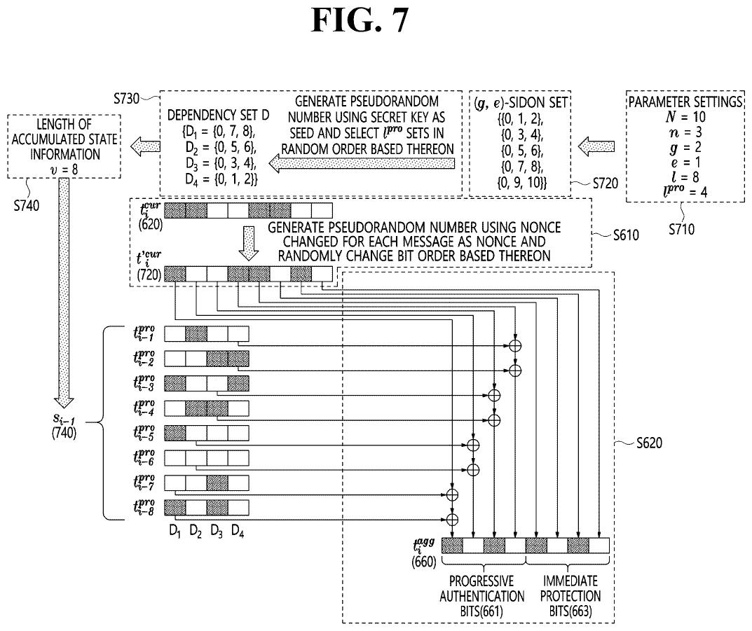

FIG. 7 is a view illustrating an example of a process of performing a progressive message authentication method for protecting stream data communications according to an embodiment of the present disclosure. FIG. 7 shows an embodiment that explains a process of generating progressive authentication bits and immediate protection bits using dependency sets and randomness based on a (g, e)-Sidon set proposed in the present disclosure and thereby generating an aggregated truncated tag.

Referring to FIG. 7, the controller 110 sets parameters at step S710. At step S710, N, n, g, e, l, and l^{pro} are set to 10, 3, 2, 1, 8, and 4, respectively.

The controller 110 generates a (g, e)-Sidon set at step S720. At step S720, {{0, 1, 2}, {0, 3, 4}, {0, 5, 6}, {0, 7, 8}, {0, 9, 10}} may be generated as a (g, e)-Sidon set.

The controller 110 generates a pseudorandom number by using a secret key 653 as a seed and selects l^{pro} elements in random order from the (g, e)-Sidon set generated at step S720 based on the generated pseudorandom number in order to configure dependency sets 651 at step S730. At step S730, {D₁={0, 7, 8}, D₂={0, 5, 6}, D₃={0, 3, 4}, D₄={0, 1, 2}} is selected as the dependency sets 651. The length of the accumulated state information, v, may be set to 8, which is the largest value among all the elements of the dependency sets generated at step S720. Accordingly, the accumulated state information 740 includes eight state information tags

$$( from {t}_{i - 8}^{p r o} to {t}_{i - 1}^{p r o} )$$

corresponding to the length, v.

At step S610, the controller 110 generates an intermediate authentication tag 620 and a state information tag 630 based on a message at step S610. At step S610, the controller 110 generates a pseudorandom number by using a nonce changed for each message as a seed and randomly changes the bit order of the intermediate authentication tag 620 using the generated pseudorandom number, thereby generating an intermediate authentication tag 720.

At step S620, the controller 110 extracts bits from the intermediate authentication tag 720 and the accumulated state information 740 based on the dependency sets {D₁={0, 7, 8}, D₂={0, 5, 6}, D₃={0, 3, 4}, D₄={0, 1, 2}} generated at step S720 and generates an authentication tag 660 by performing operation on the extracted bits at step S620. At step S620, each bit of

$${t}_{i}^{a g g}$$

is computed as follows by applying Equation (4).

$${[ {t}_{i}^{a g g} ]}_{1} = {[ {t}_{i}^{′ c u r} ]}_{1} ⊕ {[ {t}_{i - 7}^{p r o} ]}_{1} ⊕ {[ {t}_{i - 8}^{p r o} ]}_{1}$$

$${[ {t}_{i}^{a g g} ]}_{2} = {[ {t}_{i}^{′ cur} ]}_{2} ⊕ {[ {t}_{i - 5}^{p r o} ]}_{2} ⊕ {[ {t}_{i - 6}^{p r o} ]}_{2}$$

$${[ {t}_{i}^{a g g} ]}_{3} = {[ {t}_{i}^{′ cur} ]}_{3} ⊕ {[ {t}_{i - 3}^{p r o} ]}_{3} ⊕ {[ {t}_{i - 4}^{p r o} ]}_{3}$$

$${[ {t}_{i}^{a g g} ]}_{4} = {[ {t}_{i}^{′ cur} ]}_{4} ⊕ {[ {t}_{i - 1}^{p r o} ]}_{4} ⊕ {[ {t}_{i - 2}^{p r o} ]}_{4}$$

$${[ {t}_{i}^{a g g} ]}_{5} = {[ {t}_{i}^{′ cur} ]}_{5}$$

$${[ {t}_{i}^{a g g} ]}_{6} = {[ {t}_{i}^{′ cur} ]}_{6}$$

$${[ {t}_{i}^{a g g} ]}_{7} = {[ {t}_{i}^{′ cur} ]}_{7}$$

$${[ {t}_{i}^{a g g} ]}_{8} = {[ {t}_{i}^{′ cur} ]}_{8}$$

In the authentication tag 660 illustrated in FIG. 7, the first to fourth bits are progressive authentication bits 661 belonging to a portion for progressive authentication, and the fifth to eighth bits correspond to immediate protection bits 663 belonging to a portion depending only on the current message.

At step S630, the controller 110 updates the accumulated state information 740 based on the state information tag 630. At step S630, the state information tag

$${t}_{i - 8}^{p r o}$$

is deleted from the accumulated state information 740, and the state information tag

$${t}_{i}^{p r o}$$

630 generated at step S610 is added to the accumulated state information 740.

The present disclosure may provide an effect of minimizing network transmission bandwidth overhead caused by addition of authentication values (tags) and preventing degradation of security strength while guaranteeing confidentiality, integrity, and authentication of short stream data, such as control data transmitted as a real-time stream at short intervals, by applying AEAD in interference-prone wireless communication environments, such as those for drone radio controllers.

Specifically, the present disclosure is based on R2-D2 and SP-MAC, which address disadvantages of existing progressive message authentication codes (ProMACs), such as sliding-window-based multiple tag losses and increased authentication latency. Here, the present disclosure incorporates randomized bit dependencies, immediate protection bits, and g-Sidon-set-based dependencies to provide security robust to interference such as packet loss, signal interference, and degraded reception rates.

Particularly, the present disclosure proposes a (g, e)-Sidon Set including a new condition that further limits the number of occurrences of elements among dependency sets and randomly configures a dependency set D through pseudorandom selection based on a secret key and a nonce, thereby making it difficult for attackers to predict packet deletion positions or dependency patterns. Accordingly, the present disclosure may minimize the security loss caused by bit-tampering attacks on tags or by interference.

In the above-described embodiments, it may be construed that, when specified processing is applied to a specified target, specified conditions may be required. Also, it may be construed that, when a description is made such that the specified processing is performed under a specified decision, whether the specified conditions are satisfied may be determined based on a specified coding parameter and that, alternatively, when a description is made such that a specified decision is made based on a specified coding parameter, the specified coding parameter may be replaced with an additional coding parameter. In other words, it may be considered that a coding parameter that influences the specified condition or the specified decision is merely exemplary, and it may be understood that, in addition to the specified coding parameter, a combination of one or more other coding parameters may function as the specified coding parameter.

In the above-described embodiments, although the methods have been described based on flowcharts as a series of steps or units, the present disclosure is not limited to the sequence of the steps and some steps may be performed in a sequence different from that of the described steps or simultaneously with other steps. Further, those skilled in the art will understand that the steps shown in the flowchart are not exclusive and may further include other steps, or that one or more steps in the flowchart may be deleted without departing from the scope of the present disclosure.

The above-described embodiments include various aspects of examples. Although not all possible combinations for indicating various aspects can be described, those skilled in the art will recognize that additional combinations other than the explicitly described combinations are possible. Therefore, it may be appreciated that the present disclosure includes all other replacements, changes, and modifications belonging to the accompanying claims.

The above-described embodiments according to the present disclosure may be implemented as program instructions that can be executed by various computer components and may be recorded on a computer-readable storage medium. The computer-readable storage medium may include program instructions, data files, and data structures, either solely or in combination. Program instructions recorded on the computer-readable storage medium may have been specially designed and configured for the present disclosure, or may be known to or available to those who have ordinary knowledge in the field of computer software.

The computer-readable storage medium may include information used in embodiments according to the present disclosure. For example, the computer-readable storage medium may include a bitstream, which may include information described in the embodiments according to the present disclosure.

The bitstream may include computer-executable code and/or a program. The computer-executable code and/or program may include pieces of information described in the embodiments and syntax elements described in the embodiments. That is, the pieces of information and syntax elements described in the embodiments may be regarded as computer-executable code within the bitstream, and may be regarded as at least part of the computer-executable code and/or program represented as a bitstream.

The computer-readable storage medium may include a non-transitory computer-readable medium.

Examples of the computer-readable storage medium include all types of hardware devices specially configured to record and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present disclosure, and vice versa.

The progressive message authentication apparatus and method for protecting stream data communications according to the present disclosure may minimize network transmission bandwidth overhead caused by addition of authentication values (tags) and prevent degradation of security strength while guaranteeing confidentiality, integrity, and authentication by applying AEAD to short stream data such as control data transmitted as a real-time stream at short intervals in interference-prone wireless communication environments, such as drone radio-controller operational environments.

Furthermore, based on R2-D2 and SP-MAC, which address disadvantages of existing progressive message authentication (ProMACs), such as sliding-window-based multiple tag losses and increased authentication latency, the present disclosure incorporates randomized bit dependencies, immediate protection bits, and g-Sidon-set-based dependencies, thereby securing robustness to interference such as packet loss, signal interference, and degraded reception rates.

In addition, the present disclosure may make it difficult for attackers to predict packet deletion positions or dependency patterns by randomly configuring dependency sets D through pseudorandom selection, using a secret key and a nonce, from (g, e)-Sidon sets that include a new condition further limiting a number of occurrences of identical elements among dependency sets, thereby minimizing security loss caused by bit-tampering attacks on tags or by interference.

As described above, although the present disclosure has been described based on specific details such as detailed components and a limited number of embodiments and drawings, the embodiments are merely provided for easy understanding of the entire disclosure, the present disclosure is not limited thereto, and those skilled in the art will practice various changes and modifications from the above description.

Accordingly, the spirit of the present disclosure should not be construed as being limited to the above-described embodiments, and the entire scope of the appended claims and their equivalents should be understood as defining the scope and spirit of the present disclosure.

What is claimed is:

1. A method for progressive message authentication for protecting stream data communications, comprising:
generating an intermediate authentication tag and a state information tag based on a message;
extracting bits from the intermediate authentication tag and accumulated state information based on dependency sets and generating an authentication tag by performing operations on the extracted bits; and
updating the accumulated state information based on the state information tag.

2. The method of claim 1, wherein generating the intermediate authentication tag and the state information tag comprises
encrypting the message based on Authenticated Encryption with Associated Data (AEAD) to generate an initial tag; and
generating the intermediate authentication tag and the state information tag based on the initial tag.

3. The method of claim 2, wherein the intermediate authentication tag is generated using an equation below:
$${t}_{i}^{c u r} = {⊕}_{l}^{L} = {⊕}_{0 \leq k < ( \frac{L}{l} )} {[ {t}_{i} ]}_{k \cdot l + 1 : ( k + 1 ) \cdot l}$$
where tᵢ denotes the initial tag,
$${t}_{i}^{c u r}$$
denotes the intermediate authentication tag, L denotes a length of tᵢ, l denotes a length of the authentication tag and is set to satisfy l<L, and i denotes a value indicating a sequence number of the message.

4. The method of claim 2, wherein the state information tag is generated using an equation below:
$${t}_{i}^{p r o} = {⊕}_{{l}^{p r o}}^{L} = {⊕}_{0 \leq k < ( \frac{L}{{l}^{pro}} )} {[ {t}_{i} ]}_{k \cdot {l}^{p r o} + 1 : ( k + 1 ) \cdot {l}^{p r o}}$$
where tᵢ denotes the initial tag,
$${t}_{i}^{p r o}$$
denotes the state information tag, L denotes a length of tᵢ, l^{pro} denotes a bit length of a portion of the authentication tag for progressive authentication and is set to satisfy l^{pro}<l, i denotes a value indicating a sequence number of the message, and l denotes a length of the authentication tag and is set to satisfy l<L.

5. The method of claim 1, wherein the dependency sets are selected from among sets satisfying a (g, e)-Sidon set.

6. The method of claim 5, wherein the sets satisfying the (g, e)-Sidon set are selected from among g-Sidon sets such that any identical element other than ‘0’ occurs at most e times among the selected sets.

7. The method of claim 5, wherein the dependency sets are selected from among the sets satisfying the (g, e)-Sidon set based on a random number sequence generated by a pseudorandom function using a secret key used to encrypt the message as a seed.

8. The method of claim 1, wherein a length of the accumulated state information is set to a largest value among all elements of the dependency sets.

9. The method of claim 1, wherein generating the intermediate authentication tag and the state information tag comprises changing a bit order of the generated intermediate authentication tag based on a random number generated using a nonce used with a secret key used to encrypt the message as a seed.

10. The method of claim 9, wherein the authentication tag is generated using an equation below:
$${[ {t}_{i}^{agg} ]}_{m} = \{ \begin{matrix}( {⊕}_{d ∈ {D}_{m}} \{ \begin{matrix}{[ {t}_{i}^{′ cur} ]}_{m} & if d = 0 \\ {[ {t}_{i - d}^{pro} ]}_{m} & else\end{matrix} ) & if i \leq m \leq {l}^{pro} \\ {[ {t}_{i}^{′ cur} ]}_{m} & else\end{matrix}$$
where
$${t}_{i}^{agg}$$
denotes the authentication tag,
$${t}_{i}^{′ cur}$$
denotes the intermediate authentication tag with the changed bit order,
$${t}_{i}^{p r o}$$
denotes the state information tag, Dₘ denotes an m-th set among the dependency sets, l^{pro} denotes a bit length of a portion of
$${t}_{i}^{agg}$$
for progressive authentication, and i denotes a value indicating a sequence number of the message.

11. An apparatus for progressive message authentication for protecting stream data communications, comprising:
storage configured to store dependency sets and accumulated state information; and
a controller configured to generate an intermediate authentication tag and a state information tag based on a message, extract bits from the intermediate authentication tag and the accumulated state information based on the dependency sets, generate an authentication tag by performing operations on the extracted bits, and update the accumulated state information based on the state information tag.

12. The apparatus of claim 11, wherein the controller encrypts the message based on Authenticated Encryption with Associated Data (AEAD) to generate an initial tag and generates the intermediate authentication tag and the state information tag based on the initial tag.

13. The apparatus of claim 12, wherein the intermediate authentication tag is generated using an equation below:
$${t}_{i}^{c u r} = {⊕}_{l}^{L} = {⊕}_{0 \leq k < ( \frac{L}{l} )} {[ {t}_{i} ]}_{k \cdot l + 1 : ( k + 1 ) \cdot l}$$
where tᵢ denotes the initial tag,
$${t}_{i}^{c u r}$$
denotes the intermediate authentication tag, L denotes a length of tᵢ, l denotes a length of the authentication tag and is set to satisfy l<L, and i denotes a value indicating a sequence number of the message.

14. The apparatus of claim 12, wherein the state information tag is generated using an equation below:
$${t}_{i}^{p r o} = {⊕}_{{l}^{p r o}}^{L} = {⊕}_{0 \leq k < ( \frac{L}{{l}^{p r o}} )} {[ {t}_{i} ]}_{k \cdot {l}^{p r o} + 1 : ( k + 1 ) \cdot {l}^{p r o}}$$
where tᵢ denotes the initial tag,
$${t}_{i}^{p r o}$$
denotes the state information tag, L denotes a length of tᵢ, l^{pro} denotes a bit length of a portion of the authentication tag for progressive authentication and is set to satisfy l^{pro}<l, i denotes a value indicating a sequence number of the message, and l denotes a length of the authentication tag and is set to satisfy l<L.

15. The apparatus of claim 11, wherein the dependency sets are selected from among sets satisfying a (g, e)-Sidon set.

16. The apparatus of claim 15, wherein the sets satisfying the (g, e)-Sidon set are selected from among g-Sidon sets such that any identical element other than ‘0’ occurs at most e times among the selected sets.

17. The apparatus of claim 15, wherein the dependency sets are selected from among the sets satisfying the (g, e)-Sidon set based on a random number sequence generated by a pseudorandom function using a secret key used to encrypt the message as a seed.

18. The apparatus of claim 11, wherein a length of the accumulated state information is set to a largest value among all elements of the dependency sets.

19. The apparatus of claim 11, wherein the controller changes a bit order of the generated intermediate authentication tag based on a random number generated using a nonce used with a secret key used to encrypt the message as a seed.

20. The apparatus of claim 19, wherein the authentication tag is generated using an equation below:
$${[ {t}_{i}^{agg} ]}_{m} = \{ \begin{matrix}( {⊕}_{d ∈ {D}_{m}} \{ \begin{matrix}{[ {t}_{i}^{′ cur} ]}_{m} & if d = 0 \\ {[ {t}_{i - d}^{pro} ]}_{m} & else\end{matrix} ) & if i \leq m \leq {l}^{pro} \\ {[ {t}_{i}^{′ cur} ]}_{m} & else\end{matrix}$$
where
$${t}_{i}^{agg}$$
denotes the authentication tag,
$${t}_{i}^{′ cur}$$
denotes the intermediate authentication tag with the changed bit order,
$${t}_{i}^{pro}$$
denotes the state information tag, Dₘ denotes an m-th set among the dependency sets, l^{pro} denotes a bit length of a portion of
$${t}_{i}^{agg}$$
for progressive authentication, and i denotes a value indicating a sequence number of the message.
